(19) United States
(12) Patent Application Publication
(10) Pub. No.: US 2015/0196842 A1
(43) Pub. Date: Jul. 16, 2015

(54) MULTIPLAYER GAMING ON A SHARED DISPLAY

(71) Applicant: RAHA-AUTOMAATTIYHDISTYS, Espoo (FI)

(72) Inventors: Kimmo Koskinen, Espoo (FI); Jari Orkola, Vantaa (FI)

(73) Assignee: RAHA-AUTOMAATTIYHDISTYS, Espoo (FI)

(21) Appl. No.: 14/418,108

(22) PCT Filed: Apr. 16, 2014
(86) PCT No.: PCT/FI2014/050275

§ 371 Date: Jan. 29, 2015

(30) Foreign Application Priority Data
Apr. 19, 2013 (FI) 20135392

(51) Int. Cl. A63F 13/50; A63F 13/31

(52) U.S. Cl. CPC A63F 13/50; A63F 13/31

(57) ABSTRACT

A method, an arrangement, and a computer program product for a multiplayer game. The multiplayer game includes a display shared by players, a game engine and an interface unit for enabling communication between player devices, the game engine and the shared display. A game situation is formed for each player, and a summary is formed of the players' game situations. The summary of the players' game situation is transmitted to be displayed on the shared display, and the game situation of each player is transmitted to the player device of the player in question.

### BACKGROUND OF THE INVENTION

The invention relates to multiplayer gaming, and particularly to multiplayer gaming wherein players share a display.

Games are usually played for entertainment. In games for one player, a game's entertainment value is mainly brought about by the sense of fascination experienced by the player in question. A high entertainment value is generally achieved through investment in the graphical look of a game, completed with a good plot. Heavy investments in the product development of a game can be seen not only in costs but often also in the amount of storage space required by the game itself. The level of fascination may be measured, for instance, as an average time spent by a player on one game session. Such measurements may be carried out, for instance, on game sessions of test users and/or data collected from the playing of games available on the market.

A game for several players, played by the players at the same time, is usually called a multiplayer game. The fascination and subsequent entertaining value of multiplayer games are defined by social interaction with other people enabled by the multiplayer game.

Multiplayer games are known from computers and game consoles, for example. A multiplayer game may be played using a shared display, the players following progress of the game on the same display. An example of such a game is a two-player car game to be played on a television, wherein the players' cars are displayed on the television screen. In such a game, the viewing direction and size of the display determine the positioning of the players in relation to the television screen, in which case the players are usually located close to one another. Typically, interaction between players located close to one another is intensive since the players are able to interact with each other through several senses. Such interaction may employ the senses of hearing and touch, for instance. Even if the interaction were restricted even to one sense only, the players' proximity to each other enables formation of intensive sensations between the players; for instance, speech clearly communicated among the players makes different tones of voice easy to recognize in the speech.

In a conventional car game to be played on a television, the display is split among the players, and the game situation of each player is displayed in a part of its own on the shared display. However, the size of the display delimits the number of players able to play the game simultaneously without the players' proportion of the display becoming too small for playing.

In multiplayer games, such as car games, the amount of player-specific information to be displayed to each player may be quite large. Typically, such a large amount of player-specific information requires a large display area, which may vary according to the mode of display selected for the information. Consequently, in multiplayer games in particular, which use a shared display and the amount of player-specific information to be displayed is large, the shared display delimits the number of multiplayers. In practice, such limitations are taken into consideration while designing the game by setting an upper limit on the number of multiplayers. Consequently, when the number of players eager to participate in a game exceeds the upper limit on the number of players allowed in the multiplayer game, the players have to take turns to get to play the multiplayer game. This may be considered to make the game less fascinating. On the other hand, the utilization rate of the game is lowered by the time spent while changing players.

On the other hand, for the game to be played on a television, each player needs a controller of his or her own which is to be connected via wires to a game console controlling the television. The large amount of wires requires space in front of the television and a lot of connectors in the game console.

### BRIEF DESCRIPTION OF THE INVENTION

The following is a simplified summary of the invention to provide a basic understanding of some aspects of the invention. This summary is not an extensive description of the invention and is not intended to identify the important/critical elements of the invention or to define the scope of the invention. Its only intention is to present some concepts of the invention in a simplified form as an introduction to a more detailed description given below.

An object of the present invention is to provide a solution to alleviate the above-mentioned drawbacks. The object of the invention is achieved by devices, methods, and a computer program product which are characterised by what is stated in the independent claims given below. Preferred embodiments of the invention are disclosed in the dependent claims.

An aspect of the invention relates to an arrangement for a multiplayer game, the arrangement comprising a display shared by players, a game engine for executing a game logic and identifying the players, an interface unit for enabling communication between the game engine and player devices, the game engine forming a summary of the players' game situations and each player's game situation, and the summary of the players' game situation being transmitted to be displayed on the shared display and the game situation of each player being transmitted to the player device of the player in question.

According to an aspect of the invention, there is provided a method in a multiplayer game which includes a display shared by players, a game engine and an interface unit for enabling communication between player devices, the game engine and the shared display, the method comprising executing a game logic, identifying the players in the multiplayer game, forming a summary of the players' game situations, forming each player's game situation, transmitting the summary of the players' game situation to be displayed on the shared display, and transmitting the game situation of each player to the player device of the player in question.

Another aspect of the invention relates to a computer program product comprising program instructions which, when loaded on a device, cause the device to execute a method according to an aspect.

According to yet another aspect of the invention, there is provided a device comprising means configured to execute a method according to an aspect.

Other aspects of the invention are disclosed in the attached claims and the following detailed description.

Some aspects of the invention enable the efficiency of the equipment used in multiplayer gaming to be increased. Since in the multiplayer games the amount of player-specific information may be large and at the same time the number of players may be high, e.g. one hundred players, even a very large display shared by the players may turn out to be too small for displaying all players' information as well as for displaying the progress of the multiplayer game itself, for instance rotation of a roulette wheel or cards dealt in blackjack. The aspects of the present invention enable multiplayer gaming for very large numbers of players, in which case multiplayer games may be organized in large arenas, arcades and open spaces.

### BRIEF DESCRIPTION OF THE FIGURES

The invention is now described in closer detail in connection with the preferred embodiments and with reference to the accompanying drawings, in which:

FIG. 1 shows a general architecture of an arrangement for a multiplayer game to be played on a shared display;

FIG. 2 is a block diagram of a game engine according to an embodiment;

FIG. 3 illustrates how a game situation is displayed in a multiplayer game, according to an embodiment;

FIG. 4 shows a method of displaying a game situation in a multiplayer game on a display shared by players;

FIG. 5 shows a method of displaying a game situation in a multiplayer game on a display of a single player device, according to an embodiment; and

FIG. 6 shows a shared display in a multiplayer game, according to an embodiment.

### DETAILED DESCRIPTION OF THE INVENTION

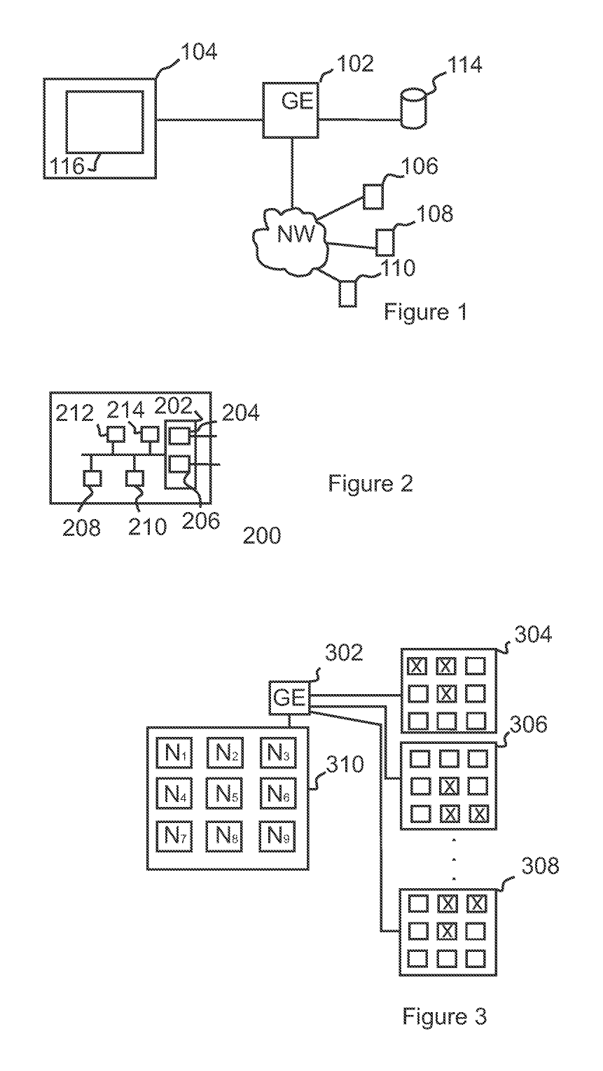

FIG. 1 shows a general architecture of an arrangement for a multiplayer game to be played on a shared display 104, according to an embodiment. A game logic of the multiplayer game is executed on a game engine 102. The game logic may be implemented as a computer program, by a mechanical arrangement, or a combination thereof. The game logic determines each game situation on the basis of game selections received from the players.

The game engine 102 is connected to player devices 106, 108, 110 and the display 104. A summary 116 of the game situation of a plurality of players is displayed on the display 104, which is shared by the players. Information to be displayed on the display may comprise image data to be displayed on the display. The image data may comprise a summary of the game situation of a plurality of players, and game progress information common to the players of the multiplayer game, such as a common gaming table. The game engine forms each player's game situation on the basis of game selections received from the players.

The game engine is connected to a database 114 which stores information on the players. The information stored on the players may comprise identifiers which identify single players or groups of one or more players. The information stored on the players may further comprise game-specific information, for instance information on the games played by the players. The game-specific information may comprise score information and settings of each game. The database may reside separately from the game engine, or it may be integrated into the game engine. The database provided inside the game engine may be stored in a memory, such as a hard disc, which is connected to an interface unit internal to the game engine, such as a data transfer bus.

The player devices 106, 108, 110 comprise a user interface via which player-specific information, such as the game situation of the player in question, is communicated to the user. Such a user interface may be e.g. a display, such as LCD (Liquid Crystal Display) and LED (Light Emitting Diode) displays conventionally used in computers and mobile stations. The user interface may further comprise means for receiving the user's game commands. Such means may, for instance, comprise a keyboard, a mouse or another selection device enabling the user's commands to be received. The user interface may also be implemented as a combination of the aforementioned, providing both display of the game situation and reception of commands. Such a user interface may be implemented by a touch screen, as is known from mobile telephones and tablet computers. Examples of player devices comprise, inter alia, a computer and a mobile station.

The player devices according to the present embodiments may comprise, for instance, a mobile station, such as a telephone, whose memory may comprise one or more commands. When the processor of the player device executes commands stored in the memory, the player device executes functions according to the present embodiments. The commands may be implemented by programming languages capable of being executed in the operating system of a mobile station and known to those skilled in the art. The commands may, for instance, comprise the game logic of a multiplayer game in order to enable participation in the multiplayer game.

The details of the user interface are device-specific. Information to be displayed on the player device and the shared display is determined game-specifically and affected inter alia by the logic of the game which in each game situation determines game selections possible for the player and a change in the game situation as well as the score on the basis of the player's selections.

The connections between the devices shown in the architecture may be implemented by wireless or wired connections which comprise, inter alia, wired and wireless connections, for instance IP (Internet Protocol) connections, and local area networks according to Ethernet and IEEE 802.11 standard

FIG. 2 is a block diagram of a game engine 200 according to an embodiment. The game engine comprises a multiplayer game controller 208, display controllers 212, 214, memory 210 and an interface unit 202 electrically connected with one another.

The interface unit comprises an input unit 204 and an output unit 206 providing input and output connections of the game engine, respectively. The memory may comprise one or more commands executable by the multiplayer game controller. The input unit and the output unit are configured or arranged to receive and transmit data, e.g. packets or frames, by using one or more wired or wireless communication protocols. The data may contain an image signal to be displayed on the displays of the player devices or on the shared display. Examples of such protocols comprise, inter alia, the following: HDMI (High Definition Multimedia Interface), SCART (Syndicat des Constructeurs d'Appareils Radiorécepteurs et Téléviseurs), VGA (Video Graphics Array), Ethernet, IP (Internet Protocol) versions 4 and 6, wireless local area network according to the IEEE 802.11 standard, ZigBee, Bluetooth, and several communication protocols used in mobile telephone networks, such as GSM (Global System for Mobile Communications) and UMTS (Universal Mobile Telecommunications System). The input unit may comprise, for instance, a radio receiver for receiving a radio frequency communication signal, and the output unit may comprise, for instance, a radio transmitter for transmitting a radio frequency communication signal.

The multiplayer game controller executes the game according to a game logic. The game logic may comprise one or more functions and/or game situation views of the game. The execution of the game logic may comprise execution of predetermined commands in the multiplayer game controller. One or more predetermined command may be executed on the basis of one or more player selections received from the users. The game logic determines the game situation to be displayed at a given moment of time on the shared display and the player devices.

While executing the game, the multiplayer game controller controls the display controllers to display the game situation on the display shared by the players and on the display of each player's player device. The display controllers 212, 214 may thus comprise a display controller shared by the players and a controller for the displays of the player devices. For each player device, a separate display controller may be used, or the displays of the player devices may be controlled by one display controller. The display shared by the players and the display of each player device may be controlled on the basis of profile information on the display in question. The display profile information may determine the size of the display, for instance as the amount of pixels in the horizontal direction of the display and as the amount of pixels in the vertical direction of the display. This enables the information to be displayed on the display to be scaled according to the properties of the display, enabling the game situation to be adapted to the display.

In an embodiment, the display controller of the player device provided in the game engine controls the game situation information to be displayed to one or more player devices. The game situation information is transmitted to the player devices via the interface unit, for instance through a wireless connection.

The display controller of the player device may reside in the game engine, as in FIG. 2, which enables the scaling of the information to be displayed on the player device to the display of the player device to be carried out also in the game engine. Thus, the information to be transmitted from the game engine to the player device may be adapted according to the properties of the player device, and unnecessary transmission of information may be avoided. It is also possible that the display controller of the player device is distributed among the game engine and the player device, in which case both the player device and the game engine are provided with a display controller unit of their own for the player device. In such a distributed arrangement, player-device-specific functions may be executed by the player device according to the profile of each player device, and functions common to a plurality of player devices may be executed by a player display controller provided in the game engine. In such a case, the game engine needs no information on the properties of the displays of the different player devices.

Preferably, the display controller of the player device provided in the game engine may have several profiles available for scaling the game situation to be displayed on the display according to the displays of different player devices. The display controller of the player device may have a profile for each different player device and/or display of the player device on the basis of which the display controller adapts the information to be displayed on the display of the player device. The profiles may comprise, for instance, profiles for 9″ and 4″ displays, in which case the display controller of the player device uses a profile corresponding to the size of the display of the player device to adapt the information to be displayed to the display of the player device.

The multiplayer game controller may comprise a processing unit. The processing unit contains a set of registers, an arithmetic-logical unit, and a control unit. The control unit is controlled by a sequence of program instructions, which are transferred to the processing unit from the memory. The control unit may contain numerous microinstructions for basic operations. The execution of the microinstructions may vary, depending on the implementation of the processing unit. The program instructions may be encoded in a programming language, which may be a high-level programming language, such as C, Java, etc., or a low-level programming language, such as Assembler. The memory may consist of several types and be a volatile memory or non-volatile memory, such as EEPROM, ROM, PROM, RAM, DRAM, SRAM, programmable logic, etc.

An embodiment provides a computer program embodied on a distribution medium and comprising program instructions which, when loaded on an electronic device, cause the processing unit to execute an embodiment according to the present invention.

The computer program may be in source code format, object code format or in an intermediate format, and it may be stored on a transfer medium that may be any entity or device that is capable of storing the program. Such transfer media comprise a storage medium, computer memory, read-only memory, electric carrier wave, data communications signal and software distribution package, for instance.

The connections between the parts of the device shown in FIG. 2 may be implemented by a communication bus providing two-directional communication between the parts of the device. Examples of such I/O buses (input/output buses) include Ethernet, ISA (Industry Standard Architecture), ProfiBus (Process Field Bus), and CANopen, for instance. The connections between the parts of the device may be implemented in different ways, depending on the level of integration between the parts of the device, which allows different buses to be used for connections between the different parts. When the memory and the processing unit, for example, are integrated into the same circuit board, communication between them may use a data transfer bus of the circuit board. In such a case, the connection of the memory and the multiplayer game controller to other parts of the device 200 may be implemented, for instance, through Ethernet, for which purpose the circuit may further comprise circuits implementing the Ethernet interface.

The device 200 may also be implemented by one or more integrated circuits, such as an ASIC circuit (Application Specific Integrated Circuit). Other solutions for implementation are also possible, such as a circuit built of separate logic components. A hybrid of these different implementation alternatives is also possible. An example of circuits built of logic components is an FPGA (Field Programmable Gate Array) circuit.

It is apparent to a person skilled in the art that the device shown in FIG. 2 may also contain parts other than those described above but irrelevant to the invention itself and thus, for the sake of clarity, left undescribed.

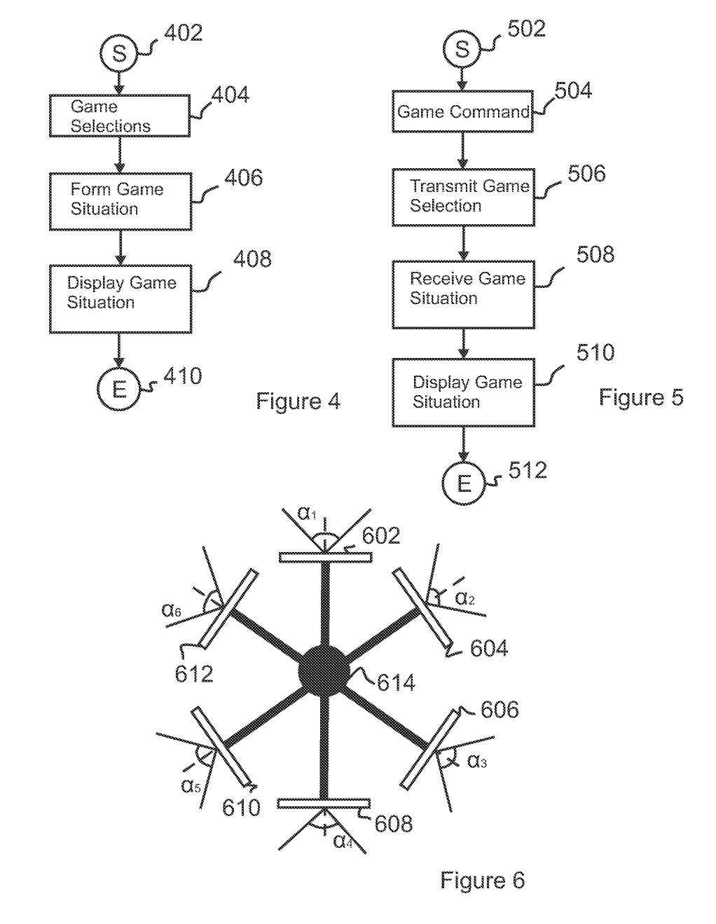

In the following, display of a game situation in a multiplayer game is illustrated with reference to FIGS. 3, 4, and 5. The multiplayer game may be implemented by the architecture shown in FIG. 1. The game engine of the multiplayer game may comply with the description of FIG. 2. FIG. 3 illustrates how a game situation is displayed in a multiplayer game, according to an embodiment. FIG. 3 shows a game situation in a game based on an exemplary game logic. It is to be noted that the present embodiments are also suitable for use in connection with other game logics. FIG. 4 shows a method of displaying a game situation in a multiplayer game on a display shared by players, according to an embodiment. The method of FIG. 4 may be executed on a game engine, for instance. FIG. 5 shows a method of displaying a game situation in a multiplayer game on a single player's display, according to an embodiment. The method of FIG. 5 may be executed on a player device, for instance.

A game engine 302 is connected 402, 502 to a plurality of player devices 304, 306, 308, and to a shared display 310. A connection is established when the game engine receives data, for instance game selections, from a player device. In FIG. 3, the player devices are shown as displays on which the game situation in the multiplayer game is displayed to each player. The display of the player devices may be a touch screen, in which case it is possible to receive commands, for instance selections associated with the game, via the display. In the game logic illustrated in FIG. 3, each display shows boxes for the players to choose from. In each player device, the boxes chosen by the player are indicated by a cross, “X”. The order of the boxes of the player devices corresponds to the order of the boxes to be displayed on the shared display. On the shared display, a summary of the players' selections, Nᵢ (i=1, 2, . . . , 9), is displayed for each box. The summary may comprise, for instance, the number Nᵢ of players who have chosen the box in question. In this example, the numbers Nᵢ of players who have chosen each box are N₁−1, N₂=2, N₃=1, N₅=3, N₅=1, and N₉=1.

The game engine receives 404 game selections from player devices connected to the game engine. It is identified from the received game selections with which player the game selections are associated. In order to identify a player and his or her game selections, a player database containing player information may be utilized. In an example, a player may be identified for the game engine by means of a user name and a password, for instance. The user name and the password and/or other information used for identifying a player may be stored in the player database. In another example, the connection between the player device and the game engine comprises a tunnel. The tunnel may be established using tunnelling protocols known to a person skilled in the art. In such a case, player selections arriving at the game engine via a given tunnel may be identified to be coming from a player device communicating with the game engine via the tunnel. This enables the player selections to be identified, for instance by means of a TEID (Tunnel Endpoint Identifier), to be coming from a particular player device.

The player device receives 504 game commands from a player through a user interface of the player device. If the player device comprises a touch screen, the touch screen may be used for both displaying a player-specific game situation to the player and receiving game commands. The game commands may comprise interpreting the player's gestures, such as touch and/or voice, as a particular command while executing the game on the player device. The player's command may be interpreted on the user interface. The interpretation may be detecting a touch on the user interface, such as detecting a touch within a certain area of the touch screen. The detected command is further interpreted as a game selection. In order to interpret the commands coming via the user interface, the player device may contain a game logic which is associated with a game to be executed on the game engine and which is executed on the player device. The game logic to be executed on the player device enables the user's commands to be interpreted as game selections to be transmitted 506 to the game engine. Further, the game logic to be executed on the player device enables the execution of the multiplayer game to be distributed among the game engine and the player devices, in which case data transfer between the player devices and the game engine may be optimized. The player logic provided in the player device may be, for instance, an application to be executed in an operating system communicating with the player through the user interface. The game application receives the player's commands via the user interface and interprets them as game selections on the basis of the game logic. Examples of operating systems comprise Apple's iOS, Google's Android, Symbian, Windows Phone without, however, being restricted thereto.

The game selections may comprise selections according to the game logic, for instance selection of a certain part of a display, such as selection of a box in FIG. 3. Further, the game selections may comprise the player's selection of a bet. The bet may comprise credits, for instance. Credits may be loaded on the game e.g. through bank giro, credit card payment or coins, as is known from coin-operated game machines, wherein a certain amount of money corresponds to a certain amount of credits.

The game engine establishes 406 a game situation on the basis of received game selections. The game situation may comprise a summary of game selections of a plurality of players and/or a new game situation for one or more players. The game situation of a single player may comprise a game result, for instance a win and/or score. Further, the game situation of a single player may comprise alternatives to be shown to the player, selections made by the player from among the alternatives, and the player's gaming implements. The gaming implements may comprise, for instance, sports equipment, such as clubs, sticks, rackets, bats or pins, available for the player while executing the multiplayer game. A game situation concerning the entire multiplayer game may comprise game progress information common to the players, in the form of a gaming table, for instance. The game may be roulette, for example, in which case the roulette wheel provides such game progress information common to all players.

The summary of the game situations is transmitted 408 to the shared display displaying 408 the game situation. Depending on the game logic, progress information on the entire multiplayer game, such as an image of the roulette wheel, may also be transmitted to the shared display. The game situation to be displayed on the shared display may be inputted to the controller of the shared display which controls the shared display to display the summary and possible multiplayer game progress information by, for instance, inputting the information to be displayed as an image signal to the shared display. The players' game situations are transmitted 408 to the players' player devices. If the displays of the player devices are controlled in the game engine, the player-specific game situation may be inputted to the display controller of the player device provided in the game engine of the player device. The interface unit of the game engine may be used for transmitting the game situation to the player devices and for transmitting the summary to the shared display.

The game situation may comprise alternatives for the players to make game selections from. In a fruit game, for instance, such as in fruit games known from slot machines, a new game situation always comprises a new result concerning the fruits available for selection. Typical fruit games comprise, inter alia, fruit games by the Applicant, wherein different fruits are illustrated e.g. on three rotatable surfaces of a cylindrical body. The rotation of the cylindrical bodies is started at the player's command, and when the rotation ends, the fruits displayed to the player comprise the game result. The game result may be called a win line, which determines the sum of money won by the player. The game may have several win lines.

The game situation is received 508 by the shared display and the player device from the game engine. The game situation may be received as an image signal which may be transferred from the game engine as a digital or analog signal by utilizing the communication protocols described above. After the game situation has been received, it is displayed 408, 510 on the display of the receiving device. The receiving device may scale the received game situation to be displayed on the display. The scaling may be carried out e.g. in the display control of the device, which scales the game situation according to the properties of the display by using, for instance, the profile of the display.

The summary of the game selections may comprise a distribution of the game selections of a plurality of players to be displayed on the shared display. The game selections may comprise selections made by the player from among several alternatives. The distribution of the game selections of a plurality of players then comprises information on the number of players who have selected each alternative. The number of game selections may vary according to the game logic and the game situation. The formation of a game situation takes place according to the game logic. The game situation may be formed on the basis of the game logic in many different ways, whereby one or more of the following may be used: game selections received from players, influence of the players' game selections on other players' game situation, game logic changing on the basis of time. An example of a game logic changing on the basis of time is that after a first player has selected an alternative, such as a particular fruit in a fruit game, the next players cannot select the same fruit, or an upper limit may be set on the number of players allowed to select a certain fruit.

In an example, the game selections of the multiplayer game comprise two or more alternatives, such as the boxes shown in FIG. 3. In such a case, the summary of the game selections may comprise the number of players for each alternative. This enables the game selections of a plurality of players to be displayed on the shared display even if the number of players is large. Particularly, the game selections of a plurality of players become easier to display when the number of players is larger than the number of alternatives for game selections. In such a case, space is used on the shared display to specify the game selections, and the players are summarized into the numbers for each alternative, according to the players' game selections. It is to be noted that if not even one player selects a certain alternative, no summary for such an alternative need be displayed on the shared display. For example, if the game selection alternatives comprise fruits known from the fruit games of slot machines, such as cherries, pine apple and orange, only the fruits selected by the players and the corresponding summaries are displayed on the shared display. This enables the items to be displayed on the shared display to be displayed sufficiently large in order for the players participating in the multiplayer game to be able to follow the game situation even from far away.

The function for displaying the game situation on the shared display and on the player device ends after the game situation has been displayed 410, 512. The above-described function for displaying the game situation may recur many times and at high speed during one game session. It is to be noted that the game situation may change also without any game selections from the user. In some game logics, game selections are required from the players, for instance in car games, that of steering the car. Without being steered by the user, the vehicle may crash and be destroyed. A destroyed vehicle may change the user's game situation, the score for instance. Consequently, the game logic may form a new game situation for the player also without game selections, in which case a changed summary of the game situations may be displayed on the shared display and the changed player-specific game situation may be displayed on the player device.

When the game situation received from the game engine is displayed on the shared display and the player device, the players are provided with both player-specific information and summary information on the multiplayer game, which is common to the players. The players thus follow their own game situation on their player devices, and the overall situation on the shared display. A combination of the shared display and the player-specific displays enables interaction of a large number of players with one another. The interaction increases the player-specific playing time in the multiplayer game and enhances the efficiency of the game engine. The efficiency H may be measured, for instance, as a ratio Hₜ=tᵤ/t_{d} of the game engine's usage time, tᵤ, to idle time, t_{d}. Since the player-specific playing time increases, the number of simultaneous players Nₚ also increases. This enables the efficiency Hₚ=Nₚ/Nₜₒₜ, where Nₜₒₜ is the number of total players, to be calculated from the number of simultaneous players. The number of total players may be obtained, for instance, from all identifiable players on whom information is stored in the database.

FIG. 6 shows a shared display 600 in a multiplayer game, according to an embodiment. The display of FIG. 6 may be used in the embodiments described above. The shared display comprises a plurality of display devices 602, 604, 606, 608, 610, 612. Each display device has a viewing angle α₁, α₂, α₃, α₄, α₅, α₆, within the area of which a person watching the display resides in order to be able to see the information shown on the display as well as possible. The display devices are attached to a frame 614 so that together they enable the display to be watched at an angle of substantially 360 degrees around the display. Such a display device may be placed, for instance, in the middle of a room for playing a multiplayer game. It is also possible that the display is placed, for instance, in a corner of the room, in which case display devices are placed only inside a sector opening from the corner into the middle of the room. In most cases, such a substantially 360 degree display enables a game to be followed by more players than a display placed in the corner of the room. A viewing angle of more than 360 degrees may be achieved by arranging the display devices at equal distances on the curve of a circle. In such a case, at a viewing angle of more than 360 degrees, the viewing angles of the display devices overlap, enabling a player to watch more than one display. Thus, even with a large group of players, a single player's risk of being left at a blind angle, for instance behind taller persons, is diminished.

In the present embodiments, the game situation may comprise a current state of the game logic while being run on the game engine. The game logic may be implemented as a computer program or electromechanical equipment or a combination thereof. The state of the game logic may comprise one or more variables and/or the state of the electromechanical equipment. The electromechanical equipment may comprise a display device, such as one or more lamps, LEDs and an LCD display, and one or more mechanical parts which may take different positions. The state of the electromechanical equipment may be determined as a view of the display device, for instance as a view on the display device, e.g. as an illuminated lamp or as a view on the LCD display. Further, the state of the electromechanical equipment may be determined on the basis of the position of the mechanical part. An example of this is the position of the rollers of a fruit game, which determines the fruit given as a game result. Such fruit games are known on the market, provided, for instance, by Finland's Slot Machine Association (RAY) already since the 1970's.

The display devices may be e.g. LCD or LED displays, or groups of single lamps or LEDs. The viewing angle and the size of the displays, display sizes of 20, 32 or 60 inches, for instance, affect the number of users who can play a multiplayer game on the shared display. The viewing distance is display-device-specific, and it is influenced by the resolution capability of the human eye as well as by the size of the items displayed on the display. In the LCD displays widely being used nowadays, such as Full-HD displays, the image size of the display is 1920 pixels horizontally and 1080 pixels vertically. The viewing distance may be calculated e.g. from the distance between image pixels. Usually, in such a case, the recommended viewing distance is a distance about three times the height of the display. This gives a viewing distance of about 0.79 m, 1.27 m, and 2.38 m for the displays of 20, 32, and 60 inches, respectively. It is to be noted that the viewing distances described above are only given by way of example, and the actual viewing distances may be greater, for instance, if the size of information to be displayed on the display is increased so as to enable the information to be seen clearly from far away.

In the present embodiments, a summary of the game situation of a plurality of players is displayed on the shared display. In such a case, even a large number of players does not decrease the size of the items displayed on the display but the size of the items is determined according to the selection alternatives given to the players, a summary of the selection alternatives being displayed on the shared display. The size of the display determines the number and maximum size of items to be displayed on the display. In such a case, the persons watching the display are situated at a viewing angle opening from the display, at a viewing distance. It is to be noted that depending on the display, it is also possible that one display device is capable of providing the players with a sufficient viewing angle and display area.

An embodiment relates to a multiplayer game whose game logic comprises several gaming implements for every player. The game may be a game of cards, for instance poker or blackjack, where each player is dealt cards. The game may also be bowling, where each player has pins and balls of his or her own. In such a case, the number of gaming implements is a multifold of that of the players, ten pins per player, for instance. The gaming implements are produced to the player through execution of the game logic. Preferably, the player-specific gaming implements are displayed on the player-specific displays, which enables even a large number of players or gaming implements to play the multiplayer game on the shared display.

The chronological order of the steps and functions described in FIGS. 4 and 5 is not absolute, and some steps and/or functions may be performed simultaneously or in an order different from the described one. Other functions may also be performed between the described steps and/or functions, or they may be included in the described steps and/or functions. Some steps and/or functions may also be omitted or replaced with a corresponding step and/or function. The functionality of the game engine may be implemented in one or more physical or logical units.

The present invention is applicable to any game engine, game machine, player device, game console, computer, mobile station, server, display device or any combination of different devices used in a multiplayer game utilizing a display shared by the players.

The devices, such as the game engine, game machine, player device, game console, computer, mobile station, server or display device, implementing the functionality of the device according to the embodiments described above comprise not only prior art means but also means for executing a game logic, identifying the players in the multiplayer game, forming a summary of game situations of the players, forming a game situation of each player, transmitting the summary of the players' game situation to be displayed on the shared display, and transmitting the game situation of each player to the player device of the player in question.

To be more precise, they may comprise means for implementing the functionality of the device described in the embodiment described above, and they may comprise separate means for every separate function, or the means may be configured to execute two or more functions.

The known devices comprise processors and memory which may be utilized when implementing the one or more functionalities described in the embodiments described above. For example, the game engine and/or the player device may comprise an application program, or a module, or a unit capable of an arithmetic function, or a program (including an added or updated software routine) executable by the processor, for instance. The programs, which may also be called a software product, comprising software routines, applets, and macros, may be stored on any data storage medium readable to the device, and they contain program instructions for executing special tasks. All changes and arrangements necessary for implementing the functionality of the disclosed embodiment may be executed through routines implementable either as added or updated software routines, application specific integrated circuits (ASICs) and/or programmable circuits. Further, software routines may be loaded on the device according to the described embodiment. The device, such as the game engine and the player device, may be implemented by a computer, or as a microprocessor, such as a single-chip computer element, including at least memory to provide a storage area to be used in arithmetic operations as well as a processor for carrying out arithmetic operations. An example of a processor is a central processing unit (CPU). The memory may be detachably attached to the device.

It is apparent to the skilled person that as technology advances, the basic idea of the invention may be implemented in many different ways. The invention and its embodiments are thus not restricted to the examples described above but may vary within the scope of the claims.

1. A method in a multiplayer game which includes a display shared by players, a game engine for executing a game logic and an interface unit for enabling communication between player devices, the game engine and the shared display to execute the method comprising:
executing a game logic;
determining a game situation comprising a plurality of alternatives for game selections;
receiving from the player devices the game selections of a plurality of players;
identifying the players in the multiplayer game from the received game selections;
forming each player's game situation on the basis of the received game selections;
determining the numbers of players who have selected each alternative;
forming a summary of the player's game situations, such that the summary comprises alternatives selected by more than zero players;
transmitting the formed summary of the players' game situation to be displayed on the shared display; and
transmitting the game situation of each player to the player device of the player in question.

2. A method as claimed in claim 1, comprising:
determining a game situation comprising a plurality of alternatives for game selections;
receiving the game selections of a plurality of players;
forming a summary comprising the alternatives and the numbers of players who have selected each alternative.

3. A method as claimed in claim 1, wherein game progress information common to the players is produced and transmitted to be displayed on the display shared by the players.

4. A method as claimed in claim 1, wherein an alternative contains an upper limit on the number of players allowed to select the alternative.

5. A method as claimed in claim 1, wherein the game situation comprises a state of the game logic, may, for instance, comprise one or more variables and/or a state of electromechanical equipment.

6. A method as claimed in claim 1, wherein the player's game situation comprises a plurality of gaming implements, for instance sport gear, displayed on a player-specific display.

7. An arrangement for a multiplayer game, the arrangement comprising:
a display shared by players, a game engine executing a game logic and identifying the players,
an interface unit for enabling communication between the game engine, player devices and the shared display, wherein the arrangement is arranged to:
determine a game situation comprising a plurality of alternatives for game selections;
receive from the player devices the game selections of a plurality of players;
determine the numbers of players who have selected each alternative; arrange the game engine to form a summary of the players' game situations and each player's game situation on the basis of the received game selections such that the summary comprises alternatives selected by more than zero players, and to transmit the formed summary of the players' game situation to be displayed on the shared display and to transmit the game situation of each player to the player device of the player in question.

8. An arrangement as claimed in claim 7, wherein the shared display comprises a viewing angle of substantially 360 degrees or more than 360 degrees.

9. An arrangement as claimed in claim 7, wherein the shared display comprises a plurality of display devices whose viewing angles overlap.

10. A computer program product comprising program instructions which, when executed on a computer, cause the computer to execute a method as claimed in claim 1.
